(19) United States
(12) Patent Application Publication
(10) Pub. No.: US 2010/0305884 A1
(43) Pub. Date: Dec. 2, 2010

(54) METHODS FOR DETERMINING THE QUANTITY OF PRECURSOR IN AN AMPOULE

(75) Inventors: Joseph Yudovsky, Campbell, CA (US); Jeffrey Tobin, Mountain View, CA (US); Patricia M. Liu, Saratoga, CA (US); Faruk Gungor, San Jose, CA (US); Tai T. Ngo, Dublin, CA (US); Travis Tesch, Santa Clara, CA (US); Kenric Choi, Santa Clara, CA (US)

Correspondence Address: MOSER IP LAW GROUP / APPLIED MATERIALS, INC., 1030 BROAD STREET, SUITE 203, SHREWSBURY, NJ, 07702, US

(73) Assignee: APPLIED MATERIALS, INC., Santa Clara, CA (US)

(21) Appl. No.: 12/781,353

(22) Filed: May 17, 2010

Related U.S. Application Data
(60) Provisional application No. 61/180,589, filed on May 22, 2009.

(51) Int. Cl. G01N 7/00

(52) U.S. Cl. 702/50; 73/31.04

(57) ABSTRACT

Methods of determining an amount of precursor in an ampoule have been provided herein. In some embodiments, a method for determining an amount of solid precursor in an ampoule may include determining a first pressure in an ampoule having a first volume partially filled with a solid precursor; flowing an amount of a first gas into the ampoule to establish a second pressure in the ampoule; determining a remaining portion of the first volume based on a relationship between the first pressure, the second pressure, and the amount of the first gas flowed into the ampoule; and determining the amount of solid precursor in the ampoule based on the first volume and the remaining portion of the first volume.

### CROSS-REFERENCE TO RELATED APPLICATIONS

This application claims benefit of U.S. provisional patent application Ser. No. 61/180,589, filed May 22, 2009, which is herein incorporated by reference in its entirety.

### FIELD

Embodiments of the present invention generally relate to processing methods utilizing vaporization of solid precursors.

### BACKGROUND

In some processing methods, for example, chemical vapor deposition (CVD) or atomic layer deposition (ALD), a precursor may be sublimed from a solid state and deposited on a substrate as a thin layer or as an atomic layer (e.g., a monolayer). Typically, the solid precursor may be contained within an ampoule or similar apparatus disposed between a gas source and a process chamber. The ampoule may be heated to sublime the precursor and a carrier gas may be utilized to transport the sublimed precursor to a process chamber where the sublimed precursor is deposited on a substrate.

Unfortunately, no reliable methods presently exist to determine the amount of depletion in the solid precursor disposed in the ampoule. This leads to sometimes inaccurate empirical correlations for the number of wafers processed before the solid material remaining in the ampoule is insufficient to provide desired film properties. In addition, due to unexpected conditions or unreliable tracking of the recipes and/or wafers processed, there is significant risk of depleting the contents of an ampoule, undesirably resulting in scrapped wafers.

Accordingly, the inventors have provided improved methods for determining the amount of solid precursor disposed in an ampoule.

### SUMMARY

Methods for determining an amount of solid precursor in an ampoule are provided herein. In some embodiments, a method for determining an amount of solid precursor in an ampoule may include determining a first pressure in an ampoule having a first volume partially filled with a solid precursor; flowing an amount of a first gas into the ampoule to establish a second pressure in the ampoule; determining a remaining portion of the first volume based on a relationship between the first pressure, the second pressure, and the amount of the first gas flowed into the ampoule; and determining the amount of solid precursor in the ampoule based on the first volume and the remaining portion of the first volume.

In some embodiments, a method for determining an amount of solid precursor in an ampoule may include determining a first pressure in an ampoule having a first volume partially filled with a solid precursor; providing a reservoir having a second volume at a second pressure different than the first pressure; fluidly coupling the ampoule to the reservoir to allow the first and second pressures to substantially equalize to a third pressure; measuring the third pressure; determining a remaining portion of the first volume in the ampoule based on a relationship between the first pressure, the second pressure, the third pressure, and the second volume; and determining the amount of solid precursor in the ampoule.

Other variations and embodiments of the present invention are provided below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic of processing system in accordance with some embodiments of the present invention.

FIG. 2 depicts a flow chart for a method for determining an amount of precursor in an ampoule in accordance with some embodiments of the present invention.

FIG. 3 depicts a flow chart for a method for determining an amount of precursor in an ampoule in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods of determining an amount of a solid precursor in an ampoule are provided herein. The inventive methods advantageously provide an in situ means of determining and/or monitoring an amount of precursor remaining in an ampoule. Such methods may advantageously reduce the risk that the precursor is completely depleted from the ampoule, which avoids the waste of substrates during processing. The inventive methods may be performed periodically, such as between processing each substrate, between processing batches of substrates, after changing process recipes, at random or desired frequencies, or the like. The precursor may be utilized for atomic layer deposition (ALD), chemical vapor deposition (CVD), or similar processes.

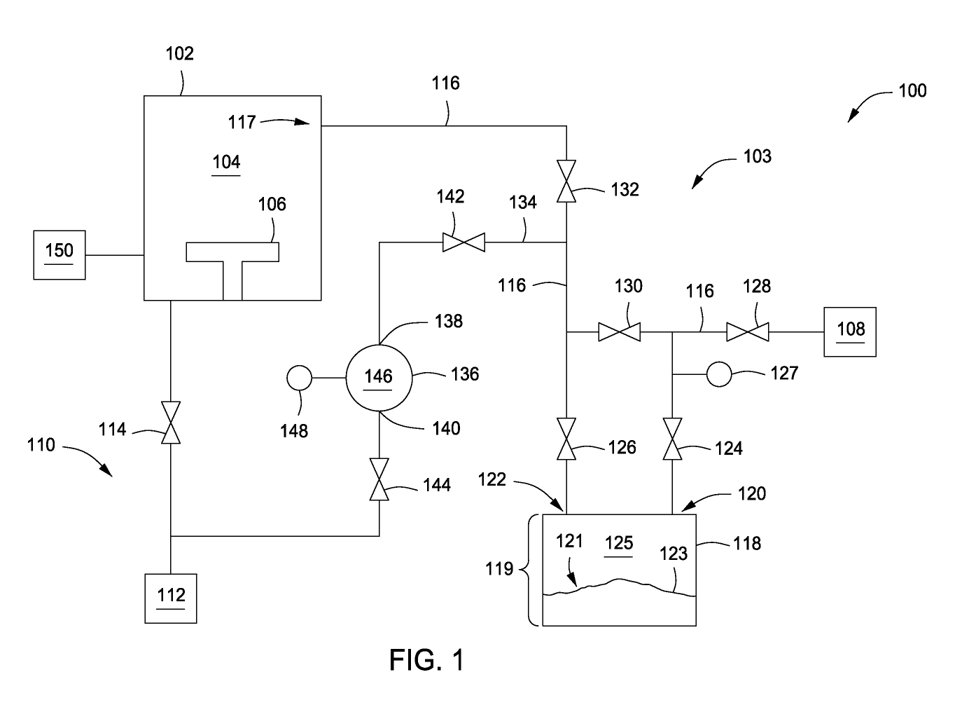

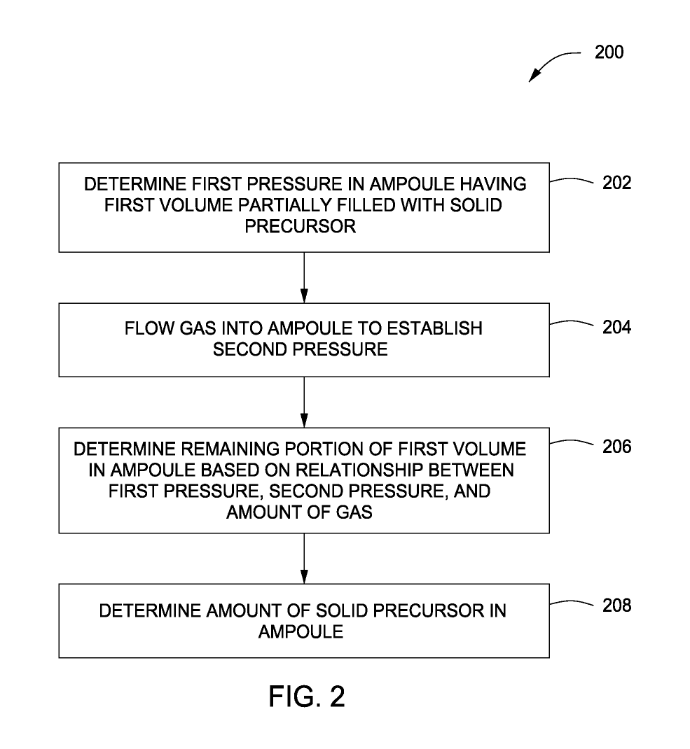

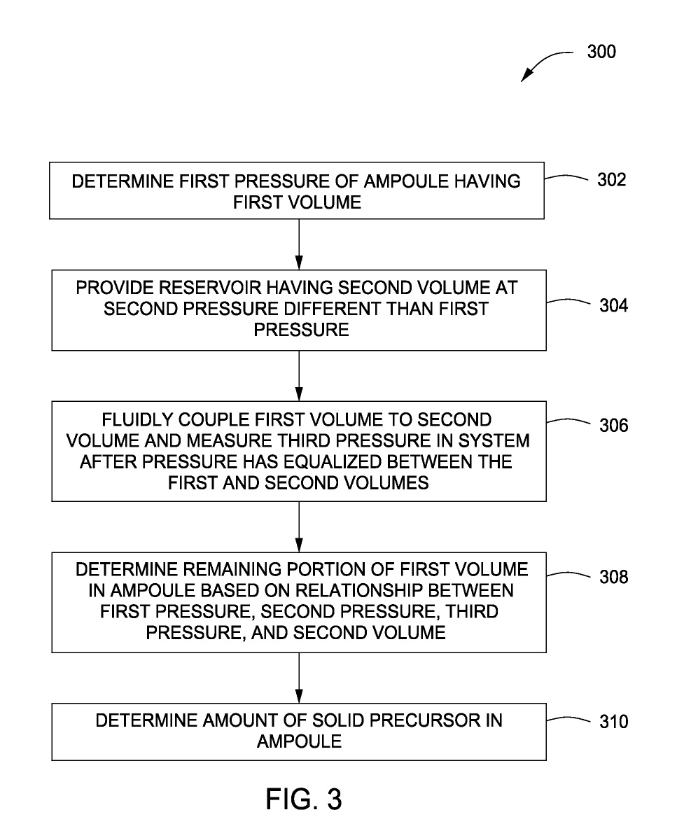

The inventive methods described below in FIGS. 2-3 may be performed in an exemplary processing system, for example, such as a processing system 100 depicted in FIG. 1. The processing system 100 may be any suitable processing system that utilizes sublimation of a solid precursor from a vessel, such as an ampoule, to deliver process gases to a substrate disposed in a process chamber of the processing system 100. For example, the processing system 100 may be configured for atomic layer deposition (ALD), chemical vapor deposition (CVD), or any other suitable process that utilizes the sublimation of a solid precursor. The processing system 100 is merely one exemplary system that may be utilized to perform the inventive methods. It is contemplated that other processing systems having other configurations may be utilized in accordance with the inventive methods described below.

The processing system 100 includes a process chamber 102 coupled to a solid delivery system 103. The process chamber 102 may include an inner volume 104 with a substrate support 106 disposed therein for supporting a substrate to be processed (such as a semiconductor wafer or the like). The process chamber may be configured for ALD, CVD, or the like. The processing system 100 may have additional components (not shown), for example, one or more RF or other energy sources (not shown) for generating a plasma within the inner volume 104 or for providing RF bias to a substrate disposed on the substrate support 106.

The solid delivery system 103 may include a gas source 108 and an ampoule 118 for holding a solid precursor. The gas source 108 may be coupled to the process chamber 102 for providing one or more process gases to the inner volume 104 of the chamber 102. In some embodiments the gas source 108 may include a mass flow controller or other suitable device for controlling the quantity of gas provided from the gas source 108. Alternatively or in combination, the gas source 108 may be coupled to a mass flow controller or other suitable device for controlling the quantity of gas provided from the gas source 108. The process gases may enter the chamber via an inlet, such as a showerhead, a nozzle, or other suitable gas inlet apparatus (side inlet 117 illustratively shown). Unreacted process gases, gas byproducts, or like may be removed from the inner volume 104 via an exhaust system 110 coupled to the chamber 102. The exhaust system 110 may include a vacuum pump 112 coupled to the inner volume 104. One or more isolation valves, gate valves, throttle valves, or the like may be disposed between the vacuum pump 112 and the inner volume 104 to selectively couple the vacuum pump 112 and the inner volume 104 (collectively illustrated as valve 114).

The gas source 108 may be coupled to the process chamber 102 via a first gas conduit 116. An ampoule 118 may be coupled to the first gas conduit 116 at one or more positions along the first gas conduit 116. For example, as illustrated in FIG. 1, the ampoule 118 may be coupled to the first gas conduit 116 at an inlet 120 and an outlet 122 of the ampoule 118 via respective valves 124, 126. The valves 124, 126 may be utilized to selectively isolate the ampoule 118 from the process chamber 102 and/or gas source 108 and to control the flow rate of gases entering and/or leaving the ampoule 118. Valves 124, 126 may be any suitable control valve, manual or automatic. In some embodiments, the valves 124, 126 may be automatic valves, such as a pneumatic valve.

The ampoule 118 includes a first volume 119. The first volume 119 may include a portion 121 which is occupied by a solid precursor 123 and a remaining portion 125 which is any portion of the first volume which is not occupied by the solid precursor 123. The ampoule 118 may be thermally coupled to a heating apparatus (not shown). For example, heating tape, or the like, may be disposed about an outer surface of the ampoule 118. The heating apparatus can be utilized to heat the solid precursor disposed within the ampoule to sublime the solid precursor. Further, the processing system 100, or components thereof, may be heated during processing. For example, the system 100 and/or components thereof may be heated to prevent condensation of the precursor (for example, on sidewall of the gas delivery conduits) during transport from the ampoule 118 to the process chamber 102.

A pressure transducer 127 may be coupled to the ampoule 118 to measure the pressure in the ampoule 118. The pressure transducer 127 may be coupled to the inlet 120 between the valve 124 and the first gas conduit 116. However, this positioning of the pressure transducer 127 is merely exemplary, and the pressure transducer 127 may be positioned in any suitable location for monitoring the pressure within the ampoule 118.

Additional valves may be utilized in accordance with a specific configuration of the gas delivery system 103. For example, in the embodiment depicted in FIG. 1, valves 128, 130, 132 are shown disposed in the first gas conduit 116, respectively positioned between the gas source 108 and the inlet 120 of the ampoule (valve 126), between the inlet 120 and outlet 122 of the ampoule (valve 130), and between the outlet 122 of the ampoule 118 and the process chamber (valve 132). The valves disclosed herein may be any suitable valve configured for use in chemical processing. For example, the valves may be suitable for use with gases, such as nitrogen (N₂), other inert gases, or the like, and/or be compatible with other gases, or vapors, such as etchants, organometallics, sublimed precursors, and the like.

A second gas conduit may be provided to couple the gas delivery system 103 to the exhaust system 110. A valve 142 may be provided in the second gas conduit 134 to selectively isolate the first gas conduit 116 from the exhaust system 110. In some embodiments, the second gas conduit 134 may include a reservoir 136 having a known internal volume (second volume 146). The reservoir 136 may have an inlet 138 and an outlet 140 for coupling the reservoir 136 to the second gas conduit 134. A valve 144 may be disposed between the between the outlet 140 and the exhaust system 110. A pressure transducer 148 may be coupled to the reservoir 136 for measuring the pressure within the second volume 146. The reservoir 136 may be utilized in accordance with the inventive methods described below with respect to FIG. 3.

In operation, for example during a process such as ALD, a process gas may be provided to the process chamber 102 by flowing a carrier gas from the gas source 108 into the ampoule 118 via the inlet 120. The ampoule 118 may be heated prior to the arrival of the carrier gas, causing sublimation of the solid precursor 123 disposed therein. The carrier gas, which may be any suitable carrier gas, such as N₂, and the sublimed precursor together exit the ampoule 118 via the outlet 122 and continue to flow into the process chamber 102 via the first gas conduit 116. The first gas conduit 116 may be heated to prevent the sublimed precursor from condensing upon interior surfaces of the fist gas conduit 116 prior to entering the process chamber 102. If a pulsed process is desired, the valve 132 may be switched at a desired frequency, such that the sublimed precursor is directed to the process chamber 102 for a first portion of a duty cycle, and directed to the exhaust system 110 for a remaining portion of the duty cycle.

A controller 150 may be coupled to various components of the processing system 100 for controlling the operation thereof. The controller 150 generally comprises a central processing unit (CPU), a memory, and support circuits for the CPU. The controller 730 may control the processing system 100 directly, or via computers (or controllers) associated with particular process chamber and/or the support system components. The controller 730 may be one of any form of general-purpose computer processor that can be used in an industrial setting for controlling various chambers and sub-processors. The memory, or computer-readable medium of the CPU may be one or more of readily available memory such as random access memory (RAM), read only memory (ROM), floppy disk, hard disk, flash, or any other form of digital storage, local or remote. The support circuits are coupled to the CPU for supporting the processor in a conventional manner. These circuits include cache, power supplies, clock circuits, input/output circuitry and subsystems, and the like. Inventive methods as described herein may be stored in the memory as software routine that may be executed or invoked to control the operation of the processing system 100 in the manner described herein. The software routine may also be stored and/or executed by a second CPU (not shown) that is remotely located from the hardware being controlled by the CPU.

During processing, such as described above, periodic determination of the quantity of precursor remaining in the ampoule may be desired to prevent depletion of the precursor to a level that may negatively impact the film properties of a film being deposited on a substrate in the process chamber 102. As such, embodiments of inventive methods for determining the amount of the solid precursor 123 remaining in the ampoule 118 are provided herein. Some embodiments of the inventive methods are depicted in FIGS. 2-3 and further described below with respect to the processing system 100 depicted in FIG. 1. Using the methods described herein, the quantity of precursor remaining in the ampoule may be determined readily and with any desired frequency. For example, the quantity of precursor remaining in the ampoule may be determined between each substrate being processed, between batches, runs, or lots of substrates, between shifts, after a predetermined period of time, or any suitable timeframe deemed desirable.

FIG. 2 is a flow chart of a method 200 for determining an amount of precursor present in an ampoule in accordance some embodiments of the present invention. In the method 200, the processing system 100 is configured such that the valves 126 and 130 are closed, effectively isolating the ampoule 118 and gas source 108 from the process chamber 102 and exhaust system 110. Valve 124 is open and valve 128 may be selectively controlled to isolate the gas source 108 from the ampoule 118 or to flow a gas into the ampoule 118. The method 200 utilizes the Ideal Gas law, rearranged to solve for the remaining volume (V_{R}) disposed in the ampoule 118 (e.g., remaining portion 125), as shown in equation (1):

V_{R}=n₁RT/P₁ (1)

where n₁ is an unknown amount of gas (e.g., moles) within the ampoule; R is the ideal gas constant; and T is the temperature of the gas within the ampoule 118 (which may be essentially the temperature of the ampoule 118). In some embodiments, the temperature T may be held constant throughout the method 200, although varying temperatures may be utilized and considered in the calculations provided herein. In some embodiments, the temperature may be approximately equal to processing conditions used during operation of the processing system 100. Although the discussion herein focuses on the volume 119 of the ampoule 118, the actual volume includes the volumes of any conduit fluidly coupled to the ampoule. For example, the actual volume contemplated by the above equation includes the volume of the conduit disposed between the ampoule outlet 122 and the valve 126 and the volume of the conduit disposed between the ampoule inlet 120 and valves 130 and 128. However, this volume may be either negligible or will cancel out of the calculations by taking account of this volume in the total volume 119 of the ampoule 118 (e.g., by adding this volume to the volume 119.)

At 202, the first pressure (P₁) in the ampoule 118 having the first volume 119 with the solid precursor 123 disposed therein is determined, for example using the pressure transducer 127. In some embodiments, the ampoule 118 may be pressurized to a first pressure set point, for example, by opening valves 124 and 128 and pressuring the ampoule 118 with gas from the gas source 108. The pressure transducer 127 may be utilized to determine P₁, as discussed above.

Next, at 204, a first gas may be flowed into the ampoule to establish a second pressure (P₂) in the ampoule and a known amount of the first gas (n₂) flowed into the ampoule. The first gas is flowed from the gas source 108 into the first volume 119 via the inlet 120 from the gas source 108. In some embodiments, a known amount (n₂) of the first gas may be flowed into the first volume 119 of the ampoule 118 and a second pressure (P₂) in the ampoule may be determined. The value of n₂ may be determined in any suitable manner, for example, by using a mass flow controller set to a desired flow rate and flowing a known amount of the first gas into the first volume 119 for a set period of time. After the known amount of the first gas n₂ is flowed into the first volume 119, the pressure transducer 127 is utilized to measure P₂. Alternatively, the second pressure P₂ may be known and the value of n₂ may be determined, for example, by measuring the period of time required to flow an unknown amount of the first gas from the gas source 108 into the first volume 119 to reach a known pressure setpoint (P₂) and then calculating n₂. Again using the Ideal Gas Law solved for V_{R}, the second pressure P₂ and the known amount of the first gas n₂ may be related to the remaining portion 125 of the first volume 119 by equation (2):

V_{R}=(n₁+n₂)RT/P₂ (2)

where n₁ is still unknown and V_{R}, R, and T have the same values as discussed above at 202.

Next, at 206, the remaining portion 125 of the first volume 119 is determined based on a relationship between the first pressure (P₁), the second pressure (P₂), and the known amount of the first gas (n₂). The relationship may be ascertained by equating the equations (1) and (2) and solving for the unknown amount, n₁. Thus, equation (3) may be determined as:

n₁=n₂P₁/(P₂−P₁) (3)

which relates n₁ to the known values of n₂, P₁, and P₂. Substituting equation (3) into equation (1), the remaining portion 125 (V_{R}) of the first volume 119 of the ampoule 118 can be determined as shown in equation (4):

V_{R}=n₂RT/(P₂−P₁) (4)

where V_{R} may be determined based upon the known values of n₂, R, T, P₁, and P₂.

At 208, the amount of solid precursor 123 remaining in the ampoule 118 may be determined by subtracting the calculated remaining portion 125 (V_{R}) of the first volume 119 determined at 206 from the first volume 119 of the ampoule 118 to determine the volume of solid precursor 123 remaining in the ampoule 118. In addition, the remaining quantity of precursor can be determined based on a relationship between the volume of solid precursor 123 and the known density of the solid precursor at the temperature, T. Upon determining the volume or amount of solid precursor 123 in the ampoule, the method 200 generally ends and additional actions can be taken based upon the determination. For example, based on the amount of remaining precursor, a determination can be made to halt or to continue processing in the processing system 100, to replenish the precursor, to adjust the frequency of monitoring of the amount of precursor, or to perform some other action that ensures the precursor is not completely depleted during processing.

Alternatively, in some embodiments, the amount of solid precursor present in an ampoule may be determined in accordance with a method 300, as depicted in a flow chart in FIG. 3. The method 300 may be performed in the processing system 100 and is described with reference to the apparatus of FIG. 1.

The method 300 generally begins at 302, where a first pressure of the first volume 119 of the ampoule 118 is determined. In some embodiments, the ampoule 118 may be pressurized to the first pressure P₁ by introducing a gas into the first volume 119. For example, the valves 126 and 130 may be closed, isolating the ampoule 118 and gas source 108 from the processing chamber 102. Valves 124 and 128 may be opened to allow gas to flow from the gas source 108 into the ampoule 118 until a desired pressure P₁ is obtained. If the ampoule 118 is already at a pressure suitable for continuing the method 300 as described herein, pressurizing the ampoule 118 is not necessary and may be skipped.

Next, at 304, a reservoir (such as reservoir 136) may be provided having a second volume (e.g., 146) that is at a second pressure (P₂) that is different than the first pressure. The second pressure may be greater than or less than the first pressure. Providing a larger difference between the first and second pressures facilitates more accurate determination of the remaining portion 125 of the first volume 119 of the ampoule 118. In some embodiments, the second pressure in the reservoir 136 may be reduced to a low pressure, for example to near-vacuum or in a milliTorr range. For example, the reservoir 136 may be evacuated by closing valve 142 and/or 132 and by opening the valve 144 to the exhaust system 110 to pump down the reservoir 136. The pressure transducer 146 may be utilized to monitor the pressure in the reservoir 136 to ensure evacuation until a pressure in the mTorr range or lower is achieved. The valve 144 may then be closed to isolate the reservoir 136.

Next, at 306, the respective volumes of the ampoule 118 and the reservoir 136 may be fluidly coupled and a third pressure (P₃) is measured after the pressure has equalized. The ampoule 118 and the reservoir 136 may be coupled, for example, via valves 126 and 142. The equalization may be considered to have ended, for example, after a predetermined period of time, or when the bother pressure transducers 127, 148 measure the same, or similar, pressure, e.g. the third pressure, P₃.

Again using the Ideal Gas Law, the remaining portion 125 of the first volume 119 of the ampoule 118 may be determined by an equation (5):

V_{R}=(P₃−P₂)V_{RES}/(P₁−P₃) (5)

where V_{R} is the remaining portion 125 of the ampoule 118 and (V_{RES}) is the second volume 146 of the reservoir 136.

Thus, at 308, the remaining portion 125 (V_{R}) of the first volume 119 may be determined based on a relationship between the first pressure (P₁), the second pressure (P₂), the third pressure (P₃), and the second volume 146 (V_{RES}) of the reservoir 136. The relationship is established by equation (5), above, which relates V_{R} to the known values of P₁, P₂, P₃, and V_{RES}. Thus, the remaining portion 125 (V_{R}) of the first volume 119 of the ampoule 118 can be determined.

At 310, the amount of solid precursor 123 remaining in the ampoule 118 may be determined by subtracting the calculated remaining portion 125 (V_{R}) of the first volume 119 from the first volume 119 of the ampoule 118 to determine the volume of solid precursor 123 remaining in the ampoule 118. In addition, the remaining quantity of precursor can be determined based on a relationship between the volume of solid precursor 123 and the known density of the solid precursor at the temperature, T. Upon determining the volume or amount of solid precursor 123 in the ampoule, the method 300 generally ends and additional actions can be taken based upon the determination. For example, based on the amount of remaining precursor, a determination can be made to halt or to continue processing in the processing system 100, to replenish the precursor, to adjust the frequency of monitoring of the amount of precursor, or to perform some other action that ensures the precursor is not completely depleted during processing.

Thus, methods of determining an amount of precursor in an ampoule have been provided herein. The inventive methods advantageous provide an in situ means of monitoring an amount of precursor remaining in an ampoule such that the precursor is not completely depleted causing the waste of substrates during processing.

While the foregoing is directed to embodiments of the present invention, other and further embodiments of the invention may be devised without departing from the basic scope thereof.

1. A method for determining an amount of solid precursor in an ampoule, comprising:
determining a first pressure in an ampoule having a first volume partially filled with a solid precursor;
flowing an amount of a first gas into the ampoule to establish a second pressure in the ampoule;
determining a remaining portion of the first volume based on a relationship between the first pressure, the second pressure, and the amount of the first gas flowed into the ampoule; and
determining the amount of solid precursor in the ampoule based on the first volume and the remaining portion of the first volume.

2. The method of claim 1, wherein flowing the amount of the first gas into the ampoule to establish a second pressure in the ampoule comprises:
flowing a known amount of the first gas into the ampoule;
measuring a pressure in the ampoule to determine the second pressure.

3. The method of claim 1, wherein flowing the amount of the first gas comprises:
flowing the first gas at a predetermined flow rate into the ampoule for a period of time until the second pressure is reached; and
determining the amount of the first gas based on a relationship between the predetermined flow rate and the first period of time.

4. The method of claim 1, wherein determining the remaining portion of the first volume comprises calculating the remaining portion of the first volume using
V_{R}=n₂RT/(P₂−P₁)
wherein V_{R} is the remaining portion of the first volume, n₂ is the amount of the first gas, R is an ideal gas constant, T is a temperature within the ampoule, P₂ is the second pressure and P₁ is the first pressure.

5. The method of claim 1, wherein determining the amount of solid precursor in the ampoule comprises subtracting the remaining portion of the first volume from the first volume.

6. The method of claim 1, wherein determining the amount of the solid precursor in the ampoule comprises determining the amount of the solid precursor based on a relationship between a volume of the solid precursor and a known density of the solid precursor at a temperature.

7. The method of claim 1, wherein the first gas is an inert gas.

8. The method of claim 1, further comprising:
flowing a second gas into the ampoule to pressurize the ampoule to the first pressure.

9. The method of claim 1, wherein the ampoule is coupled to a process chamber to provide the solid precursor in a gaseous state thereto.

10. The method of claim 9, wherein the process chamber is one of a chemical vapor deposition or an atomic layer deposition chamber.

11. A method for determining an amount of solid precursor in an ampoule, comprising:
determining a first pressure in an ampoule having a first volume partially filled with a solid precursor;
providing a reservoir having a second volume at a second pressure different than the first pressure;
fluidly coupling the ampoule to the reservoir to allow the first and second pressures to substantially equalize to a third pressure;
measuring the third pressure;
determining a remaining portion of the first volume in the ampoule based on a relationship between the first pressure, the second pressure, the third pressure, and the second volume; and
determining the amount of solid precursor in the ampoule.

12. The method of claim 11, wherein allowing the first and second pressure to substantially equalize comprises fluidly coupling the ampoule to the reservoir for a predetermined period of time.

13. The method of claim 11, wherein allowing the first and second pressure to substantially equalize comprises fluidly coupling the ampoule to the reservoir for a period of time until the first and second pressure substantially equalize to the third pressure.

14. The method of claim 11, wherein determining the remaining portion of the first volume comprises calculating the remaining portion of the first volume using
V_{R}=(P₃−P₂)Vᵣₑₛ/(P₁−P₃)
wherein V_{R} is the remaining portion of the first volume, P₃ is the third pressure, P₂ is the second pressure, P₁ is the first pressure, and Vᵣₑₛ is the second volume.

15. The method of claim 11, wherein determining the amount of solid precursor in the ampoule comprises subtracting the remaining portion of the first volume from the first volume.

16. The method of claim 11, wherein determining the amount of the solid precursor in the ampoule comprises determining the amount of the solid precursor based on a relationship between a volume of the solid precursor and a known density of the solid precursor at a temperature.

17. The method of claim 11, further comprising:
flowing a gas into the ampoule to pressurize the ampoule to the first pressure.

18. The method of claim 17, wherein the gas is an inert gas.

19. The method of claim 11, wherein the ampoule is coupled to a process chamber to provide the solid precursor in a gaseous state thereto.

20. The method of claim 19, wherein the process chamber is one of a chemical vapor deposition or an atomic layer deposition chamber.
